(19) United States
(12) Patent Application Publication
(10) Pub. No.: US 2026/0195783 A1
(43) Pub. Date: Jul. 9, 2026

(54) SYSTEMS AND METHODS FOR AGENTIC QUALITATIVE RESEARCH VIA DISCRETE BEHAVIORAL TRIGGERING

(71) Applicant: Juan Jose Ayala Rivero, Los Angeles, CA (US)

(72) Inventor: Juan Jose Ayala Rivero, Los Angeles, CA (US)

(21) Appl. No.: 19/550,840

(22) Filed: Feb. 26, 2026

(51) Int. Cl. G06Q 30/0203; G06F 40/35

(52) U.S. Cl. CPC G06Q 30/0203; G06F 40/35

(57) ABSTRACT

An orchestration system for research utilizing a Sentiment Sensor, a Synthesis Engine, and an Autonomous Conversational Agent. The system captures behavioral State-Series Data, transforms it into synthesized qualitative prompts, and manages a voice-based moderation session following a Microphone Consent Gate. The entire process is programmatically bookended by a Third-Party Survey Platform via a Silent Handover mechanism.

### FIELD OF THE INVENTION

This invention relates to an automated research orchestration system. Specifically, it relates to a multi-stage process where a Sentiment Sensor captures participant behavioral data, which is transformed via a Synthesis Layer to inform an Autonomous Conversational Agent for deep-dive qualitative probing.

### BACKGROUND OF THE INVENTION

Traditional research methodologies rely on separate quantitative (survey) and qualitative (interview) phases, often requiring manual intervention to bridge data gaps. Existing continuous-feedback tools (“dials”) are designed for human visualization rather than machine-led qualitative follow-up. There remains a need for an automated orchestration layer that can capture behavioral sentiment and immediately utilize it to drive contextually relevant AI moderation.

### SUMMARY OF THE INVENTION

The present invention provides a system that originates and terminates at a Third-Party Survey Platform (100). The system utilizes a Sentiment Sensor Overlay (110) to capture State-Series Data during a stimulus event. An Internal AI Synthesis Engine (120) processes this data into a conceptual report. Following a quantitative bridge and a Microphone Consent/Instruction Gate, an Autonomous Conversational Agent (140) executes a qualitative session based on the synthesized data. The session concludes with a Silent Handover (420) back to the primary survey environment.

### BRIEF DESCRIPTION OF THE DRAWINGS

FIG. 1 is a high-level technical architecture diagram showing the orchestration flow.

FIG. 2 is a schematic of the Discrete Pulse Interaction Interface across different device orientations.

FIG. 3 is a graphical logic diagram of the Behavioral Event Detection and Data-to-Prompt Transformation.

FIG. 4 is a functional flowchart of the Silent Handover and Termination Sequence.

### DETAILED DESCRIPTION OF THE PREFERRED EMBODIMENT

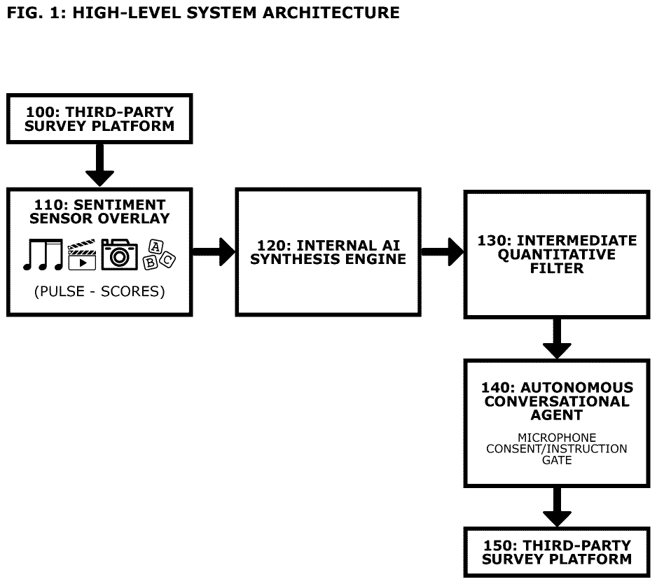

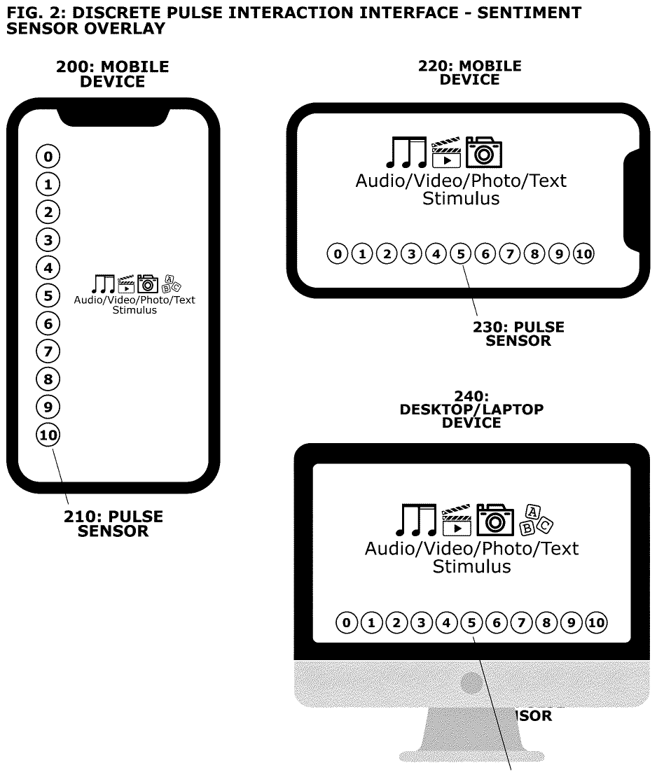

As illustrated in FIG. 1, a participant session begins at a Third-Party Survey Platform (100) for initial profiling. The participant is then presented with a stimulus via a Sentiment Sensor Overlay (110). As shown in FIG. 2, the sensor (110) presents a discrete 0 -10 button array (220). This array is configured as a Vertical Pulse Sensor (210) for mobile devices (200) and a Horizontal Pulse Sensor (250) for desktop environments (240).

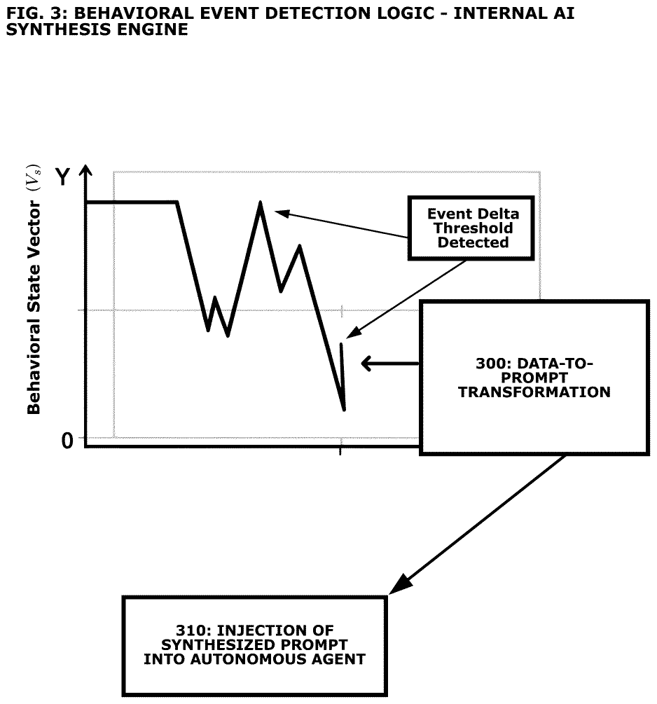

The captured data is processed as a Behavioral State Vector ($V_s$) by an Internal AI Synthesis Engine (120). As shown in FIG. 3, the engine monitors the vector to identify an Event Delta Threshold (300). Upon detection, the engine executes a Data-to-Prompt Transformation, synthesizing the numerical sentiment into a qualitative instruction.

The system may then present an Intermediate Quantitative Filter (130) (labeled 130 in FIG. 1) for additional survey questions. Access to the Autonomous Conversational Agent (140) is controlled by a Microphone Consent/Instruction Gate, ensuring regulatory compliance and audio readiness. The agent (140) utilizes the synthesized report to conduct deep-dive laddering probes.

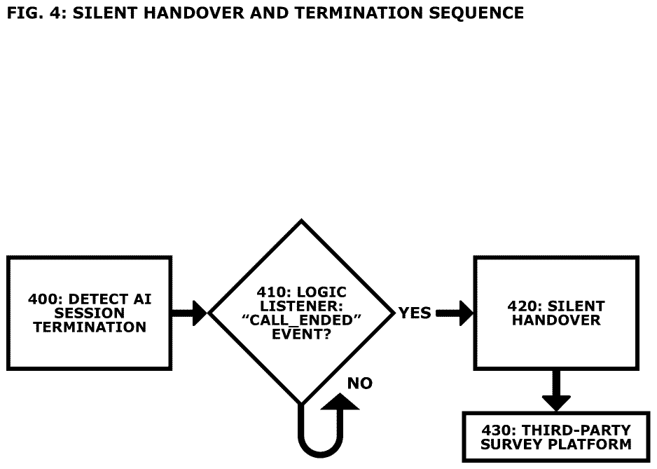

The conclusion of the session is managed by the logic in FIG. 4. A Detection Module (400) monitors the agent for termination, and a Logic Listener (410) evaluates the session for a “call_ended” event. Upon a “YES” condition, the system executes a Silent Handover (420), programmatically returning the participant to the Third-Party Survey Platform (150/430).

What is claimed is:

1. A Method for orchestrating agentic qualitative research within a digital environment, the method comprising:
Initiating a research session at a Third-Party Survey Platform (100) to collect initial participant data;
Presenting a stimulus via a Sentiment Sensor Overlay (110) and capturing participant interactions as discrete Pulse Scores;
Transmitting said Pulse Scores to an Internal AI Synthesis Engine (120) to generate a Synthesized Sentiment Report;
Verifying a Microphone Consent/Instruction Gate within an Autonomous Conversational Agent (140) prior to session initialization;
Executing an automated qualitative probing session via the Autonomous Conversational Agent (140), wherein the agent is contextually informed by the Synthesized Sentiment Report; and
Performing a Silent Handover (420) to programmatically redirect the participant to the Third-Party Survey Platform (150/430) upon detection of a session termination event.

2. The method of claim 1, wherein capturing Pulse Scores further comprises utilizing a Behavioral State Vector ($V_s$) to identify an Event Delta Threshold within a diagnostic logic trace.

3. The method of claim 1, further comprising presenting an Intermediate Quantitative Filter (130) to the participant after the generation of the Synthesized Sentiment Report but before the verification of the Microphone Consent/Instruction Gate.

4. The method of claim 1, wherein the Sentiment Sensor Overlay (110) is media-agnostic and configured to present a 0 -10 discrete button array in a Vertical Pulse Sensor (210) orientation for mobile devices and a Horizontal Pulse Sensor (250) orientation for desktop devices.

5. The method of claim 1, wherein performing the Silent Handover (420) further comprises:
Monitoring the Autonomous Conversational Agent (140) via a Detection Module (400);
Utilizing a Logic Listener (410) to identify a specific “call_ended” event; and
Executing a programmatic command to trigger the Automated Survey Redirect.
